(19) United States
(12) Patent Application Publication
(10) Pub. No.: US 2003/0208439 A1
(43) Pub. Date: Nov. 6, 2003

(54) Automated soft limit control of electronic transaction accounts

(76) Inventor: Rodger H. Rast, Gold River, CA (US)

Correspondence Address: Rastar Corporation, 11230 Gold Express Drive, Gold River, CA, 95670, US

(21) Appl. No.: 10/431,064

(22) Filed: May 3, 2003

Related U.S. Application Data
(60) Provisional application No. 60/380,003, filed on May 3, 2002.

(51) Int. Cl. G06F 17/60

(52) U.S. Cl. 705/38; 705/35

(57) ABSTRACT

A system and method of providing one or more user selectable transaction limits (soft limit) for an associated account, generally within the constraints of fixed transaction limits for the account. The soft limit may be adjusted by the user in response to anticipated transaction volume to reduce fraudulent charge risk. By way of example, the soft limit remains at a low default transaction limit that is generally sufficient for covering daily expenditures when utilizing the account, and may be temporarily set to a higher limit by the user contemplating making a purchases which may exceed the soft limit. After a time period has elapsed or a given number of transactions have occurred after user selection of the soft limit it drops back to the default value. The inventive system and method may be practiced within or interfaced to “card processing centers” of transactions cards or other account tokens.

### CROSS-REFERENCE TO RELATED APPLICATIONS

This application claims priority from U.S. provisional application serial No. 60/380,003 filed on May 3, 2002.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to the control of financial accounts and more particularly to a system and method for allowing account holders to set and automatically control a soft limit value within the hard limit constraints of a financial account thereby reducing exposure to monetary fraud for banks and individuals.

2. Description of the Background Art

The use of credit, debit, and ATM cards (hereinafter referred to generally as “transaction cards”) at the point of sale has reached an annual volume of about 45 billion transactions with a value of over 1.6 Trillion dollars, which is non-inclusive of phone orders and transactions executed over the internet. Within that transaction volume over a billion dollars is lost by banks each year due to credit card and check fraud.

The toll of fraud is especially heavy on banks with U.S. bank losses from credit card fraud totaled $901 million in 2000, which was up from $790 million in 1995, and includes losses only from fraudulent use of Visa and MasterCard bankcards, not retail, gas, or other credit cards. U.S. bank losses from check fraud totaled $679 million in 1999, compared to $497 million in 1995. The incidence of fraud is not limited to charge cards, it has been recently found that the annual cost of check fraud represents a cost of about $1 per check processed. As new forms of financial instruments become more commonly utilized these too become subject to their own risks.

The cost of transaction fraud hurts all legitimate parties, including credit card companies, businesses, and consumers, and the money extracted through fraudulent funds crime organizations which further damage our society. Credit card fraud occurs when cards are lost, stolen, or the underlying card (account) information is utilized fraudulently. In a typical fraud scenario, once a card or card information is obtained it is very quickly used, as perpetrators attempt to quickly charge items to the card before it is “maxed out”, or invalidated (such as by making an entry within the negative files that are used for checking for bad credit cards).

Unfortunately, a large sum may often be fraudulently charged on these cards in a short period of time which increases the costs of administrating card use, which of course is a cost borne by merchants as well as consumers. The banks loose revenue and individuals may be subject to an economic impact. However, even when consumers are not subject to a direct economic impact they will at least certainly be subjected to the hassles of attempting to explain away the fraudulent charges, clearing up returned checks and bad payments, and generally getting their accounts back in order. Credit card fraud as a result creates a most unpleasant situation for both parties.

One of the reasons for the high dollar losses is that users of credit card and debit cards generally need much higher spending limits than are required on a daily basis, because individual spending can be subject to wide fluctuation. Furthermore, as credit card revenue stems from carrying high balances forward, the issuing institutions do not want to discourage creditors from obtaining cards with high limit. Credit card limits are often at amounts such as $10K, $25K, or even $100K, or more, while debit card limits are typically set to the amount of the account, such as checking account. Middle class to affluent consumers generally have multiple transaction cards, often one or more credit cards among these may not have standing balances, but are retained for their advantages when making big purchases, such as a backup transaction device. It should be noted that an issuing bank on such a “backup card” is subject to the highest liability (full credit limit is available for use) while collecting little or none from interest charges and usage fees.

In practice, very high credit limits are used extremely rarely by the cardholder, however, at these times this power can be very important, while there is also a certain security, and at times pride, associated with the ability to make such a large purchase, or set of purchases with a transaction card. However, most of the available credit sits “stagnant” and unused during normal periods, with the consumer making smaller purchases. If a transaction card is stolen or lost, this excessive limit is a problem for both the consumer and the issuing bank. The possibility arises of having one's entire checking account depleted In the case of a debit card, or of receiving an enormous credit card statement at the end of the month in the case of a credit card. Consumers are intently concerned about security, with some surveys indicating it as the number one concern of card users.

Recently card issuers have tried to reduce those fears by promoting programs that drop the liability to zero, however, this will not dispel consumer fears. It should be recognized that even though the eventual liability limit for the consumer with a credit card is limited to fifty dollars if reported within two days, consumers remain concerned because the embarrassment, hassle, and time required to correct these situations can be monumental. And with cards used infrequently, a card could go missing for many days, or weeks before a consumer noticed. Debit card use can be even more problematic as they may have accrued numerous bounced checks, bad debts, and so forth while needing money to live on while trying to prove that they did not make the purchases and then getting reimbursement on their account.

Trying to encourage card issuance at lower limits is not a solution, as it does not allow for making the sporadic large purchases, or using the full credit to which they may be eligible. In addition, card issuers do not want to discourage high balances, and they court the good credit risks by offering high limits and good terms. In attempting to reduce the exposure to fraud a number of card issuers provide what is referred to as charge velocity features, or other similar terms, that refer to limiting the rate of purchases to a given amount, such as to a daily limit.

These limits, however, are non-interactive with the user's spending desires wherein the limit must still be set to a high value so consumer use of the card will not be constrained, such as having their card rejected when making a large purchase, taking a trip, entertaining clients, or similar card use scenarios. Consequently these limits provide very limited protection from fraud. It will be appreciated that a cardholder may occasionally make a huge purchase or may make a string of purchases, for instance when furnishing a new home, starting a business, sending a child to college, leaving on a trip, and so forth. Having transactions rejected at these times would be both embarrassing and inconvenient to the consumer. Therefore, a system is needed that can reduce the costs of fraud borne by the credit card companies, and the headache and worry of card holders. The automated soft transaction limit system and methods thereof in accordance with the present invention satisfies that need, as well as others, and overcomes deficiencies in previously known techniques.

### BRIEF SUMMARY OF THE INVENTION

The present invention describes an automated system and method that allows for user control of a soft transaction limit for a financial account from which funds may be withdrawn electronically subject to a validation or authorization process that occurs prior to execution of the amount. Because the soft transaction limit is generally constrained by the conventional hard limits (i.e. credit limit, account balance) it poses no additional liability, yet can afford a great deal of protection from fraud to consumers and card issuing institutions. (It should be appreciated, however, that the invention can be configured for special applications wherein card issuers alternatively allow the soft limit to exceed the card limit under specific terms and conditions—but this would be a typical.)

As an analogy of the invention, control of soft transaction limits could be thought of as providing a “stick shift” for the associated account, the user can keep the account running in low gear until they need more charge velocity, wherein they shift into a higher gear for a short period of time by initiating a simple automated transaction. The “top speed” (credit, or charge velocity) for the account is still controlled as set by the card issuer. In the preferred embodiment, the user need not remember to “downshift” back to a lower charge limit or velocity as the downshift is automatic after a desired interval has elapsed, or purchase has been executed.

The soft transaction limit, also herein referred to simply as a soft limit, allows the user to readily, and substantially unilaterally, adjust transaction limits on the account to reduce the possibility of fraud that may occur when a card is lost, or stolen, or from which the relevant account information has been procured in any manner that was not authorized by the account owner. The invention provides fraud reduction and benefits cardholders, merchants including both POS and remote transaction variety, and associated institutions, such as card issuing banks, credit card companies, and card processing vendors.

It should be appreciated that in utilizing soft limits, the charge offs resulting from card fraud can be significantly reduced without requiring every transaction to be accompanied by a personal identifier or other security measure. The present invention can be utilized with present cards and card systems with little user training.

The present system and methods provides a number of advanced features, many of which that are easily implemented, that can reduce the egregious losses from credit cards, debit cards, ATM cards, checks, and other forms of transaction tokens subject to hard limits. The present system also provides added peace of mind for cardholders, and optionally allows cardholder to receive incentives from issuers (made possible due to the reduced fiscal risk of fraud to the issuer). The transactions that may be subject to soft limits under the present invention include those made with conventional credit, debit, or ATM based cards, cards utilizing ACH (using check DDA information), as well as other transaction tokens currently subject to hard limits, such as checks, smart cards, smart wallets, internet transactions, and so forth. For simplicity these applications may be referred to herein generically as transaction cards, or transaction tokens, while the user may be referred to still as a cardholder.

Following is a list of features that may be included within the present invention, it will be appreciated that the majority of these features are optional and may be implemented on a particular account in response to institutional and cardholder desires. It is contemplated that initial implementation of the soft limit system and method may utilize only a small subset of these features, yet the system design has been designed as described herein for handling a variety of contingencies and provided a wide range of features to suit ongoing needs and applications, such as after the advantages of utilizing soft transactions limits becomes apparent as borne out by an expanding user community. It should be recognized that subsets and combinations of these features may be implemented within specific embodiments of a soft limit based system without departing from the invention. The following list of features is provided by way of example and not by way of limitation, it will be appreciated that numerous variations on the practice of the present invention can be created by one of ordinary skill without inventive efforts and without departing from the teachings of the present invention.

Varieties of Soft Limits:

Primary account types currently include credit card accounts, debit card accounts (on-line and off-line), ACH based transactions, checks and others.

Soft Transaction Limits may be Imposed On:

Credit cards—wherein cardholder is billed at end of month for transactions.

Debit cards, on-line—wherein transaction amount is immediately deducted from checking account.

Debit card, off-line—typically ACH (check based) transaction—wherein transaction amount is deducted after a “float period”.

ATM cards—wherein transaction amount immediately deducted, generally subject to low daily limit, but may be increased in combination with soft limit.

Checks—check transactions can generate automated alerts or be similarly limited.

Selectable Level of Cardholder Control of Soft Limit:

Fixed upper limit on the size of a single transactions (e.g. <$300)

Fixed rate of allowable charges over period of time (e.g. a calendar day)

Relative upper limit setting (i.e. % of balance)

Relative upper charge rate (e.g. % of monthly avg. deposits per day)

Soft limits on charge velocity—allows user over ride.

Soft Limit may be Set or Adjusted in Many Ways

Fixed limit increase for fixed period of time (i.e. 4× soft limit for 24 hours).

Bumping from current setting up through successively larger amounts.

User specified amount of increase.

User specified time duration of change.

User specified change of the default value (preferably subject to restrictions).

User selection from a list of choices.

Issuer control of the default soft limit, such as based on card activity, or balance, so as to limit fraud risk on non-performing cards.

Encouraging the Use of Soft Limits:

Various incentives may encourage the use of soft limit features, with preferably low soft transaction limits. By way of example a fixed default soft limit value may be set as a condition for receiving an account, or a rebate program created based on transaction volume and returning higher rebates in response to lower soft limit default values, lowering of selected account fees based on soft limit use, earning prizes and other items of value, and so forth.

To remind the cardholder of the feature an indicia may e placed on the card to remind the user of the ability to increase the limit and provide a contact number if desired. The use of a trademarked name for the soft limit service can be used to more readily increase awareness. Temporarily “Deactivating” transaction token (e.g. credit, or debit card):

It is during the initial period after loss or theft of a transaction token such as a credit card or debit card, that a lost or stolen card is most susceptible to fraud. However, when a transaction token, such as a credit card, is missing users are often uncertain as to the status of the card and they wait in hope the card will show up—sometimes a BIG mistake.

Encountering this situation with the present invention allows the user to immediately set a soft limit to zero, which prevents further use of the card, while they search for their cards. In this way the delay is permissible and the cardholder can reestablish normal limits if and when the card/s are found, and if not then the cards may be cancelled. They don't need to go through establishing a new account, waiting for a new card, and so forth, while the costs born by the issuing institution are reduced.

Access Controlled by a Personal Identifier as Provided by Cardholder:

Password (numeric or textual), response to a question (numeric, textual, selection, handwriting, voice), handwriting recognition, voiced data, voiced fact, etc.

Computer generated cardholder identification.

Biometric identification.

Selectable Method of Determining if Soft Limit has Been Reached:

As described above whether the soft limit has been reached is based on the transaction volume or total transaction amount. An aspect of the invention provides for computing the limit based on transactions which match select criterion, based on merchant, item or service purchased, and any other desired transaction metrics. In this way the user can, for example, exclude trusted vendors, or periodic transactions, from the computation of transactions to be compared against the soft limit threshold.

It should be appreciated that scant transaction information is generally available at the present time, beyond identification of the merchant and the transaction amounts. The card issuing database can be configured to retain the merchant identifier along with the transaction amounts, and the soft limit interface can be configured to allow the user to specify vendors to which the soft limit is not to be applied. This is particularly suited to control over the internet with online banking types of systems wherein the user can view transaction information and visually select the composition of how soft limits are to be determined.

Setting Time and Method by Which Soft Limit Changes Take Effect:

The present invention is configured to preferably allow the system and/or the user to select how a transition in soft limits is to take place. The use of soft limits is generally applicable to controlling which transactions may be executed, wherein executed transactions are later posted against the account.

However, a variation of the soft limit system may be configured which can prevent posting of charges, such as checks based on ACH, which have a float of one or two days. In this case a temporal shift of up to 48 or even 72 hours can exist between transaction and posting.

Preferably, in these applications the soft limit system automatically takes into account the time required for transactions to be posted to the account and if actual transaction execution time and date information is available, preferably utilizes that to base decisions upon.

The system is also preferably configured to allow the user to select aspects of soft limit timing, such as when a limit takes effect. This is especially important for example if the user believes they may have misplaced their card wherein they want all activity held up until they determine where their card or transaction token is located. The system is also preferably configured to allow the user to preplan for an expenditure, for example upping their soft limits to commence a few days hence in preparation for a trip being taken.

Centralized Soft Limit Control:

A single phone number, internet address, or similar communication pathway may be utilized for controlling soft limit settings on a number of different transaction tokens. User can select which one is to be changed. This is particularly useful when a transaction token (i.e. credit card or debit card) has been misplaced and the user wants to drop the soft limit to zero. This may augment the use of individual communication pathways for each transaction token which can generally be accessed more readily than generic pathways.

Selectable Application of Soft Transaction Limits:

Identification of transactions that should bypass limit or be subject to a different soft limit. For example, from a particular known payee, (in particular recurrent payments) such as a mortgage company, car loan company, etc. May be selected in response to a field, or combination of fields on transaction record, such as the payee field.

Transaction may be Selected by One or More of the Following:

As entered by account owner

As found by historical transaction queries

As found by risk assessment evaluations—databases

As found by heuristics

Identification of the party that executed the transaction to determine the metrics on bypassing the soft limit. Different soft limits may then be applied for different parties, or may be bypassed for certain users. This is applicable to multicard accounts, such as corporate cards, and card use among family members, or with college students.

Identified by the PIN number, or other personal identifier, used for the card.

Identified by extra data encoded in the card, such as its magnetic stripe.

Identification of the goods and services to determine the soft limit, or to allow or disallow the transaction. For example the UPCs of purchased items can be communicated in the transaction which are compared by classification with parameters set by the account owner to determine allowability of the transaction. Particularly applicable to multicard accounts. Transmission of UPCs with the transaction allows additional services as well, as described elsewhere.

Allowable Limit Increase ($0-$Hard Limit) Dependent Upon Identifier Used:

The extent of increase being user dependent, wherein access to a single account from multiple parties may be controlled. (Particularly well suited for use in families on a single account, or corporate accounts.) For example, president using his corporate card can bump limit more than an employee.

Transaction Logging:

Generation of a logging entry communicated to the account holder (cardholder) for any transaction over a given amount (threshold between $0 $credit limit). By way of example the communication may take the form of an email message sent to the cardholder. The email may be viewed (either directly or with the use of a decrypter routine that requires an identifier to be input), or it may be collected into a log to keep the cardholder constantly apprised of charges that have accrued, and to quickly alert the cardholder to unauthorized card (or card related information) use.

Logging transactions as based on identifier used. This, for instance, would allow a corporate entity to receive real-time information on the use of credit cards issued to employees for company purposes.

“Duress” Code Thwarts Attempts at Forced Soft Limit Increases:

A substitute or modified personal identifier is entered instead of the actual personal identifying code. This is used in situation in which the cardholder is being threatened by a perpetrator in some manner and is expected to increase their card limit under duress. Therefore, a “duress” code is entered when attempting to bump up the credit limit. Although the output of the system appears to go forward as normal (so that perpetrators do not become savvy that a wrong code has been entered) the account is set to thwart attempts at making transactions. Preferably the soft limit within the account is set to zero.

A simple “duress” code based on a PIN type of personal identifier number can be provided by entering the reverse of the normal PIN. For example: normal PIN entry of 6824, would under duress be entered as 4286, whereupon the soft limit would be set to $0 and the account optionally “flagged” so that attempts at making a transaction with the card will alert personnel to the possible attempted fraud.

“Duress” code is similar to the 7777 code entered on aircraft transponders to alert air traffic personnel that a hijacking is underway.

“Duress” Code may be Used to Thwart Forced ATM use by Parties:

To prevent a criminal from forcing a person to withdraw significant funds from an ATM machine, under duress. The account owner may in this case enter a reverse PIN number, or other code indicative of duress at an ATM to set their limit to zero, and which preferably causes the machine to act otherwise normally, except for generating a message that it is “out of money”, and that the transaction may be attempted later. The soft limit of the account would be nulled out to prevent the perpetrator from utilizing the card at other merchants establishments. No indication of the “duress” code having been entered should be visible. Alternatively, the machine may dole out a small value of cash, such as $20, with the indication that the account limit has been reached, wherein the perpetrator may be less suspicious and less likely to attempt using the card elsewhere. This provides a further aspect of the invention which may be readily implemented. It will be appreciated that the ATM software requires only simple programming changes that may be implemented by one of ordinary skill in the art.

Resolving Over-limit Conditions at the POS:

(1) Over Soft Limit—When a transaction is identified that would overshoot the soft limit.

(a) Informing the consumer of the over soft limit condition, wherein they may execute a separate soft bump transaction.

(b) Upping the soft limit at the POS—the POS is configured to allow the user to communicate a new soft limit via the system, wherein the transaction is reattempted.

(c) Requesting a PIN number or other form of identification as an authorization to exceed the soft limit. This of the invention generally involves modification of transaction infrastructure software to accept the PIN entry in this capacity.

(2) Over a fixed daily or transaction limit—This aspect of the invention can be practiced without the soft limit features described herein, wherein a PIN (or other biometric identifier) is required for executing a transaction that exceeds a daily, or per transaction limitation.

As the user will generally be aware of the need to enter their PIN, (fingerprint or other biometric) to execute the transaction, the POS system should allow the user to select if they want to enter a PIN (or collect other biometric) when swiping the card through the system.

The transaction system can be configured to generate a PIN request under certain circumstances, such as based on charge amount, daily spending, or even the type of expenditure. The POS system then returns the PIN (or other biometric) which upon being verified signals transaction authorization.

Defraying Cost of Implementation and Use:

As mentioned the use of soft limits can provide huge savings for issuing institutions by reducing card losses due to fraud. If a card is lost or stolen, the amount that the issuing institution stands to lose is less only a few hundred dollars depending on how high the soft limit is set, and not on the order of thousands, or even ten thousand dollars or more.

The soft limit control mechanisms which the user communicates with to change the soft limits, can be established by card issuing institutions for their own set of cards, wherein the cost of deploying and operating the system is an operating expense, which should be more than covered by savings that occur as a result of lower card losses. The card issuers may choose to have third parties provide the interface to consumers, wherein the third parties can be paid on a per use basis. The third party systems still communicate with a data center of the card issuer, or other party responsible for maintaining account information, so that soft limit fields may be altered within the records for the account. The number of times the service is utilized being easily determined from the database records maintained by the issuer for the sets of accounts.

Different Soft Limits Within a Single Account Using Different Identifiers:

Different soft limits may be set on a single account (checking, credit, etc.) based on the use of a user specific identifier. For example multiple cards can be issued for the same account, for example debit cards drawing from the same joint checking account. The system is configured to optionally allow a different soft limit to be tied to each different transaction token associated with an account.

For example, requiring entry of a PIN numbers for selected cards. Different soft limit may be set based on the PIN number. Changing of the soft limit is preferably restricted, partially or fully, to a given party on the same card (i.e. party with higher authority {e.g. CEO, manager, father, mother}, or through a process {e.g. communication from CEO to bank}.

Logging may be enabled for selected cards, wherein PIN entry converted to a cardholder name. All transactions for given cards may be subject to logging or a specific logging threshold limit may be set per card.

Enhanced Electronic Transaction Communication:

Presently, only the transaction amount and identification metrics of the transaction are communicated back to the account administering system, such as the computer for VISA®, or MasterCard®, or a financial institution. With the proliferation of electronic capture equipment the transaction infrastructure may be enhanced to increase the amount of information being provided to consumers while reducing the incidence of fraud.

Purchaser photo—can be captured at the POS terminal.

Purchase breakdown—providing information about the transactions such as the category and cost of each item. The breakdown may be based on UPC code and cost as provided by the POS system. Particularly applicable to newer IP POS terminals.

Logging of the data from purchases can be used to provide the user with feedback on their purchases, for populating accounting program databases, and for monitoring the use of a portion of an account by additional cardholders.

Soft limits may then be set based on the product category. Said category being derived such as from UPC codes being mapped into categories (preferably a hierarchy of detail, e.g. Audio equipment, DVD player, ACME Model 2353-1111).

Use of the additional cards for an account may then be controlled as to what items may be purchased with the card. For example, a card may be issued to an employee that needs to make specific purchases related to the job, wherein the registration of the enhanced information can provide for restricting unauthorized purchases.

Camera Incorporated Within Card Reader:

Captures an image of the person executed a transaction at the POS. The image may be utilized in a number of ways, including: automated recognition against image on file; stored in a repository in case user reported fraud has occurred with a given transaction, available as part of a transaction logging mechanism, and so forth. Large image is input by the camera to which an automatic cropping mask is applied based on the position and extent of the image.

Fingerprint Scanner Incorporated Within Card Reader:

Can be utilized as a primary identifier, or utilized as above.

In summary the present system and methods may be described as a system for controlling transaction authorization, comprising: (a) means for user control of a second transaction limit amount for an account of the user having a fixed first transaction limit amount; (b) means for submitting a transaction for execution wherein an amount and transaction token associated with the user account are submitted against which the transaction amount, such as from a POS, internet based transaction, and so forth is to be posted; and (c) means for rejecting the proposed transaction in response to information about prior transactions executed for said account, information of which is retained in the database, if execution of the submitted transaction would result in exceeding the second transaction limit of the user account.

The fixed first transaction limit generally comprises at least one limit, (i.e. a credit limit, monetary balance, fixed daily expenditure level, charge velocity, etc) to be imposed on transaction activity of the user account that can not be interactively set by the user. Typically the fixed first transaction limit comprises either a credit limit on a credit card, or a balance limit for a debit, ATM card, or check based transaction vehicle.

The user changes the second transaction limit amount (soft limit) by establishing a communication over a communication channel (wired or wireless telephone connection, an internet connection, or other electronic medium over which user input may be transmitted) with a networked computer system capable of accessing user account information within which the second transaction limit (soft limit) is maintained, and by way of a user an interface they can alter soft limit values within the associated database, which typically contains additional account such as hard account limits and identification information. One preferred method of allowing a user to set the soft limit is over a telephone network wherein an interface is configured as an automated telephone application (i.e. IVR application) which generates voice prompts and registers user input as dual-tone multifrequency coded key inputs or voice responses. Transactions subject to the soft limits of the present invention may be submitted by any convenient method for processing and posting against the user account. Most typically transactions are captured and submitted at a point of sale, or by a merchant over a communication link after capturing the necessary account information from the user (typically a cardholder).

The networked computer system which maintains account information for the user account is modified under the present invention to maintain the soft limit information and to reject a transaction if its execution against the user account would cause the soft limit to be exceeded.

The system may also be described as a system for controlling transaction authorization for user accounts, comprising: (a) at least one networked computer system capable of accessing account information for a plurality of users, the account information including fixed transaction limits not interactively selectable by the user, and soft transaction limits which may be selected by the user within the constraints of the fixed transaction limits; and (b) programming on said at least one computer for, (b1) updating the soft transaction limits in response to user input, (b2) receiving information about prospective monetary transactions, (b3) rejecting prospective monetary transactions whose execution would exceed the soft limit.

The programming is preferably configured to automatically reset the soft transactions limits to a default value (or a user selected second “Base level” soft limit) after a predetermined time interval has elapsed (preset value or value selected by the user), or a given number of transactions (such as specified by the user) since said soft transaction limit was set by the user to a value exceeding the soft limit default value.

The invention may also be described as a method of controlling which transaction charges are to be accepted against a monetary account, under the control of the owner of the monetary account, comprising:

establishing a soft limit feature within the account database for administering monetary transactions with respect to the monetary account, by entering the following information into the database which is accessed for authorizing transaction charges associated with the monetary account by,

activating the soft limit feature within the monetary account of the owner, wherein the allowable range of the soft limit is constrained to be at or below the allowable credit limit, or credit balance, within the monetary account,

configuring a default soft limit value to which charge transactions executed against the account are to be limited, and above which the charge transactions are to be denied,

establishing at least one personal identifier for use by the owner of the monetary account, or parties authorized to use the monetary account by the owner, to be associated with the control of the soft limit feature for the monetary account;

modifying the value of the soft limit to alter the allowable extent to which charge transactions may be executed against the monetary account by,

establishing communication with an automated information system associated with the monetary account which is configured for authorizing transactions directed toward the monetary account based on database information retained in conjunction with the automated information system, communication being established by the owner, or a party authorized by the owner, for modifying portions of the database to which the authorization is responsive,

entering an account identifier for receipt by the automated information system for selecting which monetary account is being referenced by the owner or authorized party,

entering the at least one said personal identifier associated with the monetary account for receipt by the automated information system for validating the authority of the owner, or authorized party, to modify the soft limit values;

specifying a new soft limit value by the owner, or party authorized by the owner, to alter the monetary limit by which subsequent transactions are to be restrained;

wherein the soft limit alters the amount which may be charged to the associated account subject to the control of the account owner, or party authorized by the owner.

A transaction token, typically a credit card, debit card, or ATM card, is associated with the monetary account. The transaction token or information from the transaction token (i.e. name, account number, expiration date from a card), are utilized for executing the monetary transaction.

Typically the soft limit is expressed as a allowable transaction amount for a given period of time, such as expressed in hours or days. The preferred period for retaining raised soft limit values by the user is one day. The default soft limit value may be set by the user under in some instances constraints by the issuer (i.e. maximum default value of the default limit as condition of card issuance). The default soft limit lowers risk to issuer allowing them to issue card to parties that would otherwise pose a less than favorable risk to return ratio. The default soft limit generally comprises a “normal” transaction limit typically substantially less than the credit limit, or credit balance associated with the monetary account, and preferably can be set to a value between zero monetary value on up through to a value equal to the credit limit, or credit balance. The soft limit may be further subject to other restrictions below said credit limit, or credit balance, according to the limitations of use imposed for said monetary account.

A number of additional optional aspects of the system and method are described. One aspect of the invention provides for the generation of a logging entry which is communicated to the account holder (cardholder) for any transaction over a given amount. The logging entry may be communicated, such as a via email message, back to the cardholder. The cardholder can view the information, (may require a proprietary viewer if the logging entries are encoded or encrypted to prevent others from accessing them), or the information may be collected into a log, or used to populate a database (e.g. within an accounting program, or similar) to keep the cardholder constantly apprised of charges accrued, and to quickly alert the cardholder to unauthorized card (or card related information) use.

The present invention may be utilized in conjunction with account earmarking services such as described in U.S. patent application Ser. No. 09/970,379 entitled “Method and System of Earmarking Transactions and Allocating Balance Contributions within a Modular Financial Account”; and U.S. patent application Ser. No. 10/066,495 entitled “A System and Method of Maintaining Consumer Privacy During Electronic Transactions”, these applications being included herein by reference.

An object of the invention is to limit the monetary exposure of banks and individuals to fraud relating to the use of credit cards, and similar accounts that may source electronic transactions.

Another object of the invention is to enhance cardholder control of the way in which their monetary account is utilized for electronic transactions.

Another object of the invention is to provide cardholder control of the transaction limits on an account that may be implemented for various accounts for which an electronic verification is performed prior to executing the transaction.

Another object of the invention is to provide an account charge limit control feature that may be easily modulated by the account owner (typically referred to as a cardholder) through any convenient communication mechanism.

Another object of the invention is to provide security in modulating account charge limits wherein only the cardholder is provided control access.

Another object of the invention is to provide a “duress” security feature in which the cardholder can enter a known code alternate to indicate a duress situation wherein account activity should be at least temporarily restrained.

Another object of the invention is to provide a “duress” security feature which is based on a variation of a known identifier, for example a reverse of the standard identification number, which is easily remembered and not recognizable is a “panic code” to others.

Another object of the invention is to provide a system and method of modulating the effective charge limit of an account that may be implemented anywhere within the electronic transaction infrastructure, such as standalone systems, third party service vendors, current account control mechanisms, point of sale systems, financial institutional account control systems, and combinations thereof.

Another object of the invention is to provide a system of modulating the effective charge limit which provides a mechanism for maintaining multiple charge limits for a single account wherein the charge limits may be associated with additional cards for a given account and the soft limits invoked based on information provided on the card, or the an entered identifier or auxiliary identifier.

Another object of the invention is to provide a mechanism for reducing fraudulent credit card charges by selectively requiring the entry of an identifier, to validate the user, in response to the monetary amount involved in a given transaction.

Another object of the invention is to provide a system in which selected executed electronic transactions are reported back to the account owner or cardholder.

Another object of the invention is to provide a system in which extended transaction information is collected during execution which may be utilized for reducing the instance of fraud and/or reported back to the account owner or cardholder.

Another object of the invention is to provide a system of modulating the effective charge limit by selectively applying soft limits to transaction amounts, and allowing other transactions, such as issued to known parties (i.e. mortgage company, car financing, etc.) to bypass the soft limits for execution.

Another object of the invention is that of determining/selecting when soft limit controls are to take effect, such as automatically determined by the system and/or based on user selection, received transaction information, or vendor information (i.e. trusted vendors).

Another object of the invention is to provide a system of selectively applying soft limits wherein the transaction stream is compared with historical data to determine if the soft limits should be applied to a given transaction.

Another object of the invention is to provide a system of modulating the effective charge limit and of communicating information about all executed transactions, or executed transactions subject to selection, such as based on identifier used, transaction amount, cumulative transaction total for a given period, and so forth.

Another object of the invention is to communicate information about executed transactions in a form that is non-interruptive to the cardholder and capable of being stored, such as using electronic mail.

Another object of the invention is that soft limit control may be performed through centralized communication channels allowing soft limits to be set for a number of different types of transaction tokens.

Another object of the invention is that the communicated information is subject to password protection (or other identifier), encoding, encryption, or combinations thereof.

Another object of the invention is that the communicated information is adapted for receipt in a log form that may be retained within the transaction infrastructure for retrieval by the cardholder.

Another object of the invention is that the communicated information is adapted for receipt in a log form that can interface with, or populate, databases of account information such as for software applications (i.e. word processors, spreadsheets, bill paying programs, accounting programs, etc.).

Another object of the invention is to provide transaction infrastructure enhancement wherein POS devices capture one or more cardholder images during a transaction.

Another object of the invention is to store images captured by POS based camera devices for retrieval by the cardholder, or account administrator, should questions arise about possibly fraudulent charges.

Another object of the invention is to store fingerprint scans, or other biometric identifier captured by a POS based terminal for retrieval, such as by the account administrator or law enforcement personnel in response to suspected fraudulent charge activity.

Another object of the present invention is to modify current account processing procedures to incorporate automated notification of an account owner in the event that a questionable transaction, or a potential overdraft, or NSF condition has arisen.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of a system utilizing soft transaction limits according to an embodiment of the present invention, shown utilizing transaction intermediaries for hosting soft limit control.

FIG. 2 is a block diagram of a soft limit system according to an embodiment of the present invention, shown with soft limit processing being performed in the regional data center.

FIG. 3 is a block diagram of a soft limit system according to an embodiment of the present invention, shown ACH based soft limit processing being performed.

FIG. 4 is a flowchart of transaction processing according to an aspect of the present invention in which soft limit checking is performed.

FIG. 5 is a flowchart of soft limit control according to an aspect of the present invention.

### DETAILED DESCRIPTION OF EMBODIMENT(S)

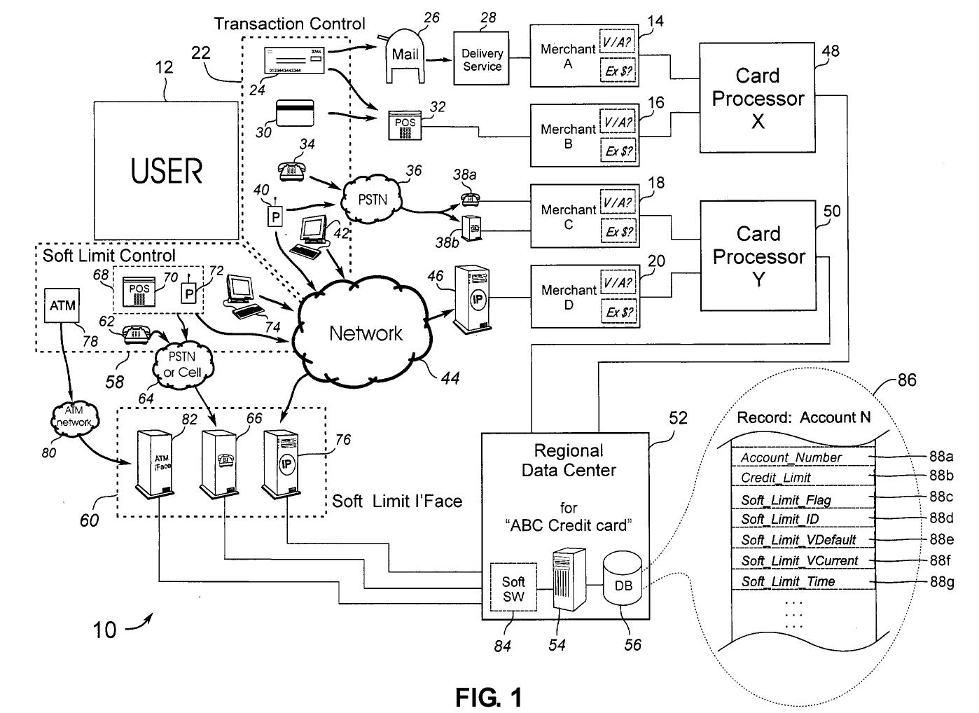

Referring more specifically to the drawings, for illustrative purposes the present invention is embodied in the apparatus generally shown in FIG. 1 through FIG. 5. The detailed description exemplifies specific embodiments of the invention which are described in sufficient detail so as to allow a person of ordinary skill in the art to practice the invention without undue experimentation. It will be appreciated that the apparatus may vary as to configuration and as to details of the parts without departing from the basic concepts as disclosed herein.

Transaction execution is herein considered to be the event which generally takes place subsequent to the allowance or acceptance of a transaction. For example, during a purchase transaction with a credit card, the charge is authorized (e.g. found in a database query of one or more databases, such as the data center of the credit card company or issuing institution) and then the charge is executed by electronically submitting payment information so that the vendor is credited with the transaction amount and the associated cardholder account is accordingly debited. It should be recognized that transaction execution does not infer that the financial transfer of funds has occurred. For example, in using an ACH based debit card, the financial transfer which is generally referred to as a settlement process, may not occur for 24-48 hours after the debit card has been accepted as payment for the goods, which is considered execution of the transaction.

By way of example, the validation/authorization process referred to herein may take the form of a database query to check account status, determine a verification of the account information, an authorization based on account balance or credit balance and account limits to charge the amount of the transaction, or combinations and variations thereof. Any means (process element) within the present transaction infrastructure that performs, or may perform, validation/authorization of a transaction may be configured to check a user selectable transaction limit as defined within the present invention.

The present invention may be utilized for executing soft limits with accounts associated with credit cards, debit cards, ATM cards, or even checks subject to ACH authorization to limit the allowable transaction amount, either according to absolute monetary terms, relative transaction values, or to the rate of charge accumulation. A soft transaction limit is controllable by the account owner, “typically a cardholder” (although Smart Cards, and other account information bearing “tokens” may be similarly utilized), and set to a value generally below the hard limit of the associated account and is preferably adjustable from zero up to the hard limit for the given account, or beyond those boundary ranges in selected applications. Entering and/or activation of a soft limit is subject to identifying the party proposing the soft limit change, such as by requiring the entry of some form of personal identification, such as a PIN number.

The term credit card, debit card, ATM card, or just “card” within the context of the present invention is considered to comprise a transaction token associated with a financial account that may be accessed electronically using account specifiers within or upon the token. The token may alternately have no physicality other than being one or more identifiers which may be submitted in order to execute a transaction. Traditionally, these accounts are associated with plastic cards having a magnetic stripe that may be utilized with a point of sale card reader, or information about the underlying account may be conveyed by other means, such as by listing an account number and other identifying information. It should be appreciated that the present invention may be utilized with any form of account representation that wherein an electronic interchange occurs prior to completion of transaction execution and settlement. The system may be utilized with transactions that are settled in real-time, or transactions that are settled at a later date (such as ACH based transactions). Aspects of the invention may even be utilized for transactions, such as check transactions, that are not being subjected to a verification/authorization process during transaction execution, and which proceed directly toward settlement. The “electronic transaction” being controlled by the present system may be one that is generated as an electronic transaction such as an internet purchase, or one that is converted to an electronic transaction, such as a mail order purchase made over the phone or a point of sale purchase in which a card may be swiped through a reader terminal. It will be appreciated that any account subject to a limitation at the time of validation/authorization by checking of account related information prior to execution of said transaction may be controlled utilizing said system. It is not important that an underlying “card” be available for utilizing the present invention, however, typically the accounts are associated with credit, debit, and ATM cards, that are configured with a magnetic stripe, a computer chip, or other form of data retention device for use within POS systems.

To understand the system it should be recognized that conventional accounts are subject to a hard limit, such as a credit limit, or an account balance. The limit is considered “hard” as it is not controllable, as a parameter, by the account owner (cardholder). Hard limits may exist for one or more reasons, for example a credit limit on a credit card, an account balance on a monetary accounts such as a checking account and so forth, a limitation imposed by a financial institution, and other forms of limitations (fixed daily limits, charge velocities, and so forth) which are placed on the amount which may be transacted in toto or rate based wherein the account owner is unable to perform a substantially unilateral and rapid change of the limit. Conventionally, a hard limit can be modified by a daily limit or other charge velocity limit that can limit card usage, however, it should be appreciated that these limits may not be readily controlled unilaterally in response to a communication generated by the user to an automated system which allows the user direct control of transaction execution within the bounds of an overarching hard limit that defines the total amount of credit or funds available within the associated account. Modifications of transaction infrastructure to accomplish user directed substantially unilateral modulation of these card velocity limits being considered another lesser preferred aspect of the present invention. Currently, lacking the ability to rapidly and unilaterally alter these transaction limit values, these velocity features provide only marginal benefit as they must be set very high so that the cardholder is not unduly limited in using the associated account.

In the case of a credit cards, the hard limit generally would comprise the credit limit of the account as fixed by the credit card company, for instance based on a risk analysis performed during qualification. The credit limits are typically set for incremented values such as $3K, $5K, $10K, $25K, $50K, $100K, and so forth. In the case of a debit card, ATM, or check, the hard limit is associated credit balance remaining in the account, generally referred to as a checking account. Although the hard limit may include overdraft protection credit, it typically does not as account balances are generally reported and not the balance plus overdraft credit.

It will be appreciated that a checking account associated with a debit card has no “credit card limit” per se as the cardholders bank balance determines the limit, however, the account balance generally establishes the upper, hard, limit on the monetary volume of transactions which may be executed according to the balance amount. The soft limit according to the present invention operates under user control within the bounds of the hard limit. An ATM card is similar in many respects to the use of the debit card, however, traditionally these cards are issued with small, fixed, transaction limits. Employing soft limit features the hard limits of ATM style card account could be extended provide enhanced control of transaction execution.

It should be recognized that in some cases a cardholder may contact a credit vendor and extend the limit of a credit card, or lower the limit, however, it will be appreciated that these require approval by the charge card company, generally require a period of time to take effect, are not presently configured for automatic unilateral change, and are not presently configured for being modulated on a periodic basis. However, it will be appreciated that since a user does not select the amount of credit they are entitled to, just as they do not unilaterally select their checking account balance (aside from depositing and removing of funds which is not unilateral), the modulation of a credit card limit unilaterally by the user would constitute the implementation of a soft limit within a hard limit set by the account balance or the credit to which the card issuer, or other credit institution, had authorized for the account owner. Therefore, attempts to alter the naming of account limit entities to sidestep the soft limit distinction, must be examined in terms of functions rendered by said implementations in relation to the teachings of the present invention.

Soft limits according to the invention may be implemented in numerous alternative ways. It will be appreciated that modification of conventional hard limits, and rate limits, and so forth to create a sub limit, or soft limit, entity (it would of necessity have a hard limit) that modifies transaction verification/authorization limits and may be altered substantially unilaterally by the account owner, is generally considered within the teachings of the present invention. Typically, the soft limit comprises a database entity that defines a unilaterally user selectable transaction limit (absolute, relative, rate, and so forth), and computer programming (such as for a data center, ACH node, or other transaction processing computer system) that in response to the soft limit entity is capable of altering the verification/authorization process so that transactions outside of the bounds of the user set limits are not executed. In the present invention the user is granted additional account control which may reduce both transaction losses and aggravation for users, merchants, and the financial community at large.

A preferred mode of operating the soft limit feature of an account is for the account owner, or institution, to establish a default soft limit value that may be over-ridden in response to a communication from the account owner (or party authorized by the account owner) to increase (or decrease) the “soft” transaction limit on an account for a given period of time in preparation for an enlarged (or decreased) amount of transaction activity. It should be recognized that an institution which administers the account may set restrictions on the default soft limit, for example as a metric associated with account qualification, reduced rates, purchase rebates, incentive programs, and so forth. This temporary increasing (“bumping”), or decreasing (“dumping”) of a default soft transaction limit reduces the need to decrease the limit after the transaction. It should be appreciated, however, that the present system is preferably implemented to allow the account owner to alter the default soft limit to any limit at or below the hard limit, subject to the terms of the account. Generally the account owner is referred to as a cardholder in reference to a card form of transaction token being tendered, or from which the information is otherwise gathered, for executing of a given transaction.

By way of example, a default daily soft limit is set to limit the daily volume of transactions allowed (i.e. $200), and the cardholder telephones (e.g. via an “800” number of other form of toll-free number), sends an email, goes online on the Internet to access a web site associated with said account, accesses an ATM machine, makes an entry at a POS terminal to a card processing entity involved in performing the validation and/or authorization, or otherwise communicates with the present system to “bump” up their soft limit in preparation for increased transaction activity. The transaction then is allowed under the increased soft limit, and the default soft limit value is restored at a later time, such as the following day wherein the monetary impact of fraudulent charges being applied to a lost or stolen card are reduced.

By way of further example consider the following scenario. In utilizing a preferred embodiment of the present system for a credit card, consider an individual that has a $50K credit card limit (hard limit), that establishes a default soft limit of $300 per day, based on their nominal card usage. They may charge up to $300 per day in their normal manner. However, when they want to charge more than $300 in a given day they must “bump” the soft limit in the account, for example temporarily to span a 24 hour transaction execution period. After the period elapsed, the soft limit would return to its default value without the necessity of the cardholder performing a restorative downward decrease “dump” of the soft limit. Typically, the “soft limit bump” would be performed prior to a specific transaction, or a period of high usage. However, the soft limit bump may be performed at the time of the transaction, such as at a point of sale system that is adapted for receiving an identifier from the cardholder to validate the soft limit extension. It will be appreciated that although an identifier may be provided over a communication link (e.g. telephone, or Internet connection) to a merchant for executing a soft limit bump this in most cases would be considered to compromise security.

The account owner, generally a “cardholder” for a transaction sourced in relation to a card based transaction token, can communicate with an automated system adapted to modulate the soft limits associated with the given account in a number of alternative ways according to practicing the present invention.

Provided by way of example, and not of limitation, are a number of those alternatives:

(1) Connecting via a Telephone, or Cellular Phone:

For example, calling an 800 number to an automated system, such as that utilized to provide card activation, or to process account inquiries. A preferred embodiment can utilize a modified version of the automated phone response systems presently utilized for activating credit, debit, and ATM cards, in which the account is identified, such as by entering account number, whereafter an identifier may be required such as zip code. These systems in most cases check the phone number of the caller as well and check this against the account, and it is the reason why the card must be activated from the phone number associated with the account.

(2) Connecting via a Data Network Connection:

For example, using a computer, laptop, PDA, smart phone, pager, and so forth. This communication may take the form of an email, a visit to a web site, a proprietary communication, or other means for communicating data over the network. A server on the Internet, or other form of data network connectivity, allows for account number registration and the identification of the account owner, or cardholder, and provides an interface through which the soft limit value, or values, may be controlled for the associated account. If provided on the Internet, a server may receive this information from the cardholder in the form of an email, preferably secure, or via a web site interface. Using email allows the cardholder to easily control their soft transaction limit from PDAs and similar devices having limited bandwidth and display capability. The email communication may be secured by using a plug-in or application on the cardholder device which has an interface to collect user selections and packages the resultant information into a secure, preferably encrypted format, for delivery to the system.

(3) Making a Connection Through the Point of Sale Terminal:

For example, communicating a request along with associated personal identification (biometric, PIN, or so forth) through a point of sale system. The request could be preferably made at any time, however, specific POS terminals and merchant policies may only allow access during the entry of a transaction. The POS terminal preferably also generates a reminder to the account owner if the purchase amount exceeds the soft limit wherein the account owner can enter information to bump the limit up, whereupon the POS terminal may reapply the transaction amount and proceed to execute the transaction. Account owner (cardholder) personal identification may be provided in any convenient, and approved format compatible with the POS terminal, for example, a PIN number, a biometric scan, as well as other forms of identification may be utilized. The PIN (or other biometric) may be considered as an authorization to exceed the soft limit since the party attempting to execute the transaction has thus been verified. The database software that performs transaction authorization is modified to check the intended transaction against the limits, and to generate a request for PIN entry in response to soft limit or other limit for which identification is necessary to overcome. The PIN entry is then validated and the transaction can be allowed. It will be appreciated that the authorization system is preferably configured to initially check hard limits as well as the soft limits or other account limits, and to refuse the transaction, without asking for a PIN, if the transaction would exceed the account hard limit. This identification may be the same one as used for accessing the account or it may be a different identifier that is in accord with the use of the feature. In this way the user need not perform a separate task prior to making the large purchase, while security is nonetheless maintained.

The transaction infrastructure may also be modified to require PIN (or other biometric entry) to validate transactions which are over any limit such as daily limit, single transaction limit, and so forth.

(4) Connection via an Applications Connected With Transaction Infrastructure:

For example, a connection may be provided through another application or hardware operably connected to the transaction infrastructure. One example of this is the incorporation of the soft limit features into a purchasing agent such as described within the application “A System and Method of Maintaining Consumer Privacy During Electronic Transactions”, Ser. No. 10/066,495, by same applicant which is to be included herein by reference.

(5) Connection via an Financial Institutional Applications:

For example, the features of the present invention may be controlled through other systems that provide access to the transaction infrastructure, or given account, such as banking systems. Typically these applications are those associated with the bank that issued a debit, credit, or ATM card for which the control of a soft limit, or another aspect of the present invention is sought.

(6) Electronic Bill Presentation and Payment Services:

For example, the features of the present invention may be included within, or controlled from within, extended banking or similar account services such as those described within the U.S. patent application “Method and System of Earmarking Transactions and Allocating Balance Contributions within a Modular Financial Account”, Ser. No. 09/970,379, which is to be included herein by reference.

As mentioned above, one preferred embodiment of the soft limit system and method is to modify the resources currently utilized for activating a credit card. When a credit card, debit card, or ATM card, or similar physical transaction token is received by way of a physical delivery medium, such as the postal service, it must be activated prior to use. The activation process assures that the proper party received the card before it gets activated. Typically the activation process is performed by calling a toll-free number and providing account and cardholder information in response to a set of questions generated by an IVR (Interactive Voice Response) system. The DTMF (Dual Tone MultiFrequency) digits entered, or voice responses are registered in relation to each question and generally converted to textual or numeric information. If the information provided is accurate, then the system modifies one or more account parameters, such as within credit card, or debit card database which allows for a positive response when a transaction is attempted. Furthermore, data may be loaded into the positive files to indicate a valid card.

Another preferred method of collecting and communicating soft limit information back to the database relies on adding options to existing systems for getting charge account information such as balance, next payment due, address to send payment and so forth. An option can be added to the IVR system for controlling soft limits wherein the user is allowed to select the set of options allowed by the card issuer. These account information systems are already configured to identify the account and the calling party (such as requiring an identifier), wherein the collection of other information is readily implemented.

Another preferred method of collecting and communicating soft limit information back to the database can be implemented by adding options to online banking applications to change soft limits for the account. It is generally preferred that web based soft limit changing applications be separate from vendor sites and similar sites having inadequate security, or trustworthiness, so that account information and information for controlling the account does not fall into the wrong hands.

It should be appreciated that any conventional system for managing aspects of an account can be modified with selections (options) associated with controlling soft limits for the account. Additionally, new systems may be configured specifically for controlling soft limits, or in combination with other features while following the teachings herein.

These existing applications may be modified to provide options to allow a cardholder to enter information which would be communicated to the underlying account database for controlling the soft limits and other aspects of the present invention. As these system are already configured for the receipt of an account number and identification, the system need only identify an additional function for setting the soft limit for the card and provide an interface through which the soft limit may be checked, set, and modified. It will be appreciated that more than one soft limit criterion may exist, such as default soft limit and current soft limit; soft limits for different trust levels of transactions; and so forth. With advanced interfacing soft limits may be compared against sums of all transactions or selected transactions.

Preferably, a default soft limit is set at the time of card issuance to a value according to desires of the cardholder or the provisions of the account. A current soft limit may then be set which preferably reverts back to the default value after a predetermined interval has elapsed, such as 24 hours. It is to the economic benefit of financial institutions and parties within the transaction infrastructure that cardholders utilize their soft limit feature, and furthermore that they establish low default soft limit values. Therefore, it is preferable that cardholder incentives are provided to encourage use of the card features. For example, a fixed default value as a condition for receiving an account, a rebate based on transaction volume wherein the lower the average default value used the better the percentage returned, lowering of selected account fees, earning prizes and other items of value, and so forth. A number of similar business methods can be derived from the above in providing financial incentives for establishing low soft limits on card and the use of soft limits by cardholders.

When providing the soft limit features according to the present invention, it may be desirable to include an indicia on the associated transaction token, such as card, to remind the user of the existence of the soft limit, or other feature, according to the invention. The indicia may indicate a number to call, web site, an option for soft limits on a user interface, or just be a reminder that soft limits are in effect on the card. It is anticipated that fraud could be curtailed on cards bearing the soft limit identifier because criminals would not find it worth the trouble to take the risks of being caught for the smaller available credit up to the soft limit.

Prior to making a large purchase, or when a period of higher daily expenditures are expected, the cardholder communicates with the automated soft limit control system, enters their account number and one or more personal identifiers (which may be entered numerically, be voiced, or other similar identifiers preventing others from extending the limit on a lost or stolen card, or card information), wherein the system temporarily increases the soft transaction limit to which their account is subject. Presently, a user may call and supply similar information for receiving account balance information, and otherwise controlling an account. Preferably, the system generates an acknowledgement that the soft transaction limit has been extended for a given period of time. Preferably, the user may also enter an amount to which the transaction level is to be extended, and/or a time period over which the extension is to be active.

As can be seen, the establishment, control, and abiding by soft transaction limits provides a number of benefits toward reducing fraud within the present transaction landscape. Another benefit of the soft limits is in allowing an individual to temporarily suspend a transaction card so that no new transactions may be executed on it during a period of time. Presently, persons that are unable to find their credit cards, or other executable account tokens, will in a large proportion of cases delay reporting the cards missing, as they presume, or hope, that they just misplaced the wallet, purse, or whatever that contained the cards and these will show up soon enough. It will be appreciated that the canceling of a card and the subsequent reestablishment of a new account can be difficult, time consuming, and leave the account owner without a credit card for some time. Therefore, it is hardly surprising that many, perhaps a majority, of cardholders delay the reporting of missing cards unless the circumstances of loss have left no doubt about the status of the credits cards. However, it is during the initial period after loss or theft that a lost or stolen card is most susceptible to fraud. The present invention allows the user to immediately set a soft limit to zero, which prevents further use of the card, while they search for their cards. In this way the delay is permissible and the cardholder can reestablish normal limits if and when the card/s are found, and if not then the cards may be cancelled.

It may be preferably to provide an alternate identifier, or code, that may be used strictly for zeroing out the soft limit, (without preventing the normal identifier from also being used for setting the soft balance, even to zero if desired). A service may then be provided to cardholders wherein a database retains information necessary for zeroing out the soft limits on a number of card held by the cardholder. The use of the special “zero-out” soft balance identifier increases the security as the account holder need not divulge a code that could be used for expanding the default soft limit. This security may be further enhanced by the use of account number aliasing wherein a alias for the account number is provided by the card issuer for purposes of identifying a given account, such as for temporarily deactivating the card or reducing the soft limit therein.

Furthermore, persons often keep inactive cards in drawers or other locations, which are subject to be illicitly used. Using a soft limit on these cards can prevent a non-performing card from being a liability to the issuer. A method aspect of the present invention has the card issuer alter the default soft limit of a card in response to the level of transactions experienced on a card. Additionally, a soft limit can be imposed on a standard card that is no longer meeting given activity criterion, such as after one month of non-use. A reminder would be sent to the cardholder in this case indicating the new status of the card, and preferably would include a sticker for them to attach to the existing card noting the soft limit feature so the cardholder will remember to bump the limit as needed prior to use. The soft limit could even be set to $0, in some cases such as an alternative to canceling the card altogether.

To prevent an individual from increasing their limit under duress, such as from a mugger, an “under duress” selection, such as a code entry, which appears to provide the desired soft limit bump the mugger is asking for while it actually temporarily lowers the soft limit or more preferably temporarily deactivates the given card. Notice may even be provided that if the card issued after duress code activated that a camera could be activated, police notified, or other actions taken to aid in apprehending the individual. The duress code is preferably implemented as a code of the same general structure as the identifier that is easy to remember for the cardholder. More preferably the duress code comprises the reverse of a numeric identifier code, such as a PIN normally used for bumping the limits. As a result of receiving a “duress code”, processing and acknowledgement of the transaction appear as if the soft limit bump was taking place, so that the assailant would not be savvy to the trick. For example, entering the code backwards, wherein the transaction limit would appear to increase, from listening to the conversation, however, instead of increasing the transaction limit it will be temporarily set to $0 and a notice generated when accessed of a stolen card. This is an example of one way by which the mugger, or other perpetrator would be prevented from extending the limits of the card.

Another aspect of the present invention aids in providing a small reduction in fraud without using the soft limit features so far described. This aspect of the invention requires a cardholder personal identifier, such as a PIN, to be entered for transactions whose monetary value exceeds a fixed or variable amount, even when transactions using that card would otherwise not be subject to that requirement. Typically credit cards and certain debit cards do not require the use of an identifier. This feature makes the necessity of an identifier dependent on the amount of the transaction when the card would otherwise not require one. This feature is easily implemented, within the transaction infrastructure, because during verification/authorization the transaction value is checked and if it exceeds the predetermine level the cardholder is requested to enter their identifier. Preferably, a reason is also displayed, such as “charge>$200 enter PIN”, wherein the PIN is compared conventionally as a step in the process toward executing the transaction.

It should be appreciated that the soft limits described within the present invention generally apply to each individual transaction token (e.g. credit card, debit card, ATM card, Smart card, checks, etc.) utilized by a given consumer. Wherein the consumer could elect how to use these transaction tokens in response to the soft limits established therein. For example, a consumer may elect to perform all regular transactions (car payment, mortgage) using ACH (checks or check based debit) subject to a first set of soft limits, and to make purchases on a credit card or debit card subject to a second set of soft limits. This could apply even if the checking or debit card were associated with the same account. However, the present invention provides methods for further increasing consumer account control, and the reduction of fraud.

Considering the continuing increase in the use of EBPP (Electronic Bill Presentation and Payment) systems, account owners may execute very large, often periodic transactions, as credit, debit, or ACH transactions over the present infrastructure. These transactions may come into an account from a single transaction token, wherein high value trusted transactions are executed, such as from the EBPP system to utilities, mortgage companies, along with other less trusted transactions. It will be appreciated, therefore, that the soft limit associated with a given account, or one of the possibly numerous transaction tokens associated with the account, should in these cases, not prevent execution and settlement of these bills, while the setting of soft limits above the value of these bills can severely reduce the protection provided. In consideration of this, execution and even settlement of transactions in some instances may be controlled by optional aspects of the present invention. Selected transaction may be allowed to bypass the soft limit protection subject to other criterion being met, such as the transaction being directed to a trusted party. For example, the transaction may be to a known party as listed by the account holder, to a trusted party as determined from a risk analysis, or to a company or vendor to which regular payments are being made by said account owner (historical check on prior transactions). It will be appreciated that the risk of a given transaction may be determined on additional metrics other than transaction amount. It will be appreciated that a mortgage payment to a known financial institution to which the account owner has executed similarly sized transactions is at a very low risk of being fraudulent. However, a transaction over the internet to an unknown vendor selling consumables, or easily fenced articles, is at far higher risk of being fraudulent. The present invention provides for selection of additional soft limits, or control of when the soft limits are applied, in response to additional or alternative metrics of the transaction.

Perhaps the most important additional metric is to whom the payment is being made. The user may establish a list of trusted vendors, and it will be recognized that historical transaction queries, risk assessment evaluations, and/or heuristics, and so forth may be utilized for deciding whether a given transaction should be subject to a soft transaction limit. Furthermore, a number of soft limits may be implemented within the account whose selection may be determined according to class of transaction payee. For example a transaction request from a finance company to which mortgage payments are regularly sent would either overcome the soft transaction limit, or be subject to a very high trusted entity soft transaction limit. The use of these higher soft limits provides protection from fraud and errors being propagated into the user account. It will be appreciated that a list of trusted entities based on account history or user entry may be easily created for evaluating transaction metrics, such as payee, in accordance with the selection of one or more soft limits.

The above additional selection criterion may also be utilized in addition to, or in-lieu of a soft limit verification/authorization check, for selecting which transactions the account owner should be automatically alerted to. For example, high value checks above a predetermined limit or a soft limit that are not to a known, or trusted party, could trigger the generation of an automated communication, such as an email, to the account owner.

Furthermore, the present system provides the ability of providing a soft limit on check transactions to a given limit per check, or less preferably a time period. This aspect particularly applies to checks being subjected to a verification/authorization process at the point of sale using ACH, or converted at the point of sale from a paper form transaction to electronic by way of an ACH transaction or similar, wherein the check and associated transaction may be denied in response to the soft limit and no transaction is thereby executed.

The check based feature, however, may also be implemented for notifying the account owner of suspicious checks or for delaying settlement pending verification of a transaction that does not meet soft limits, or trusted party lists, established for the account. For example, the account owner may establish a set of limits and a set of vendors (or these may be derived from account history (payees found in historical record=known parties), risk analysis based business databases, and so forth. When a check arrives that exceeds the soft limit and has a high risk of fraud (e.g. high value and to an unknown internet vendor, or unknown person) an automated alert is generated to the account owner, preferably an email, although very suspicious activity may warrant other forms of automated alert such as automated telephone message. In addition since the check is scanned, anomalies in the check image, such as unusual smudging, areas appearing in slightly different tones, different line styles, widths and so forth on high value checks should be flagged for closer inspection, wherein again the check image may be sent to the account owner for verification. More preferably, when a check is received for an amount above the soft limit and to a party not within the set of known payee parties, the check may be held pending immediate confirmation from the account owner. The confirmation is preferably performed by the financial institution immediately upon registering the account information, wherein the account owner is notified by email, telephone, FAX, or other communication link so that the status of the transaction can immediately verified. The present invention can eliminate the occurrence of NSF which occur as the result of fraud, and reduce the anxiety and difficulties that an account owner is subject to. Control of the soft limit in this situation is also controllable according to the invention, wherein the account owner may increase the limit to allow a large check to a previously unknown party (unknown in relation to an established list or historical information retrieved from the account) or may specifically submit a check number of range of check numbers that are to bypass the soft limits.

Optionally, the account owner may when writing a large check for an unknown party, generate a communication to the computer of the financial institution, such as using a specially adapted email receiving account for the financial institution, wherein receipt of the check will match up with the communication to verify the value and validate that it was indeed authorized by the user. The evaluation of checks allows the account owner to intercept, or be notified about, large checks prior to their settlement within their respective account.

A soft limit on checking can be particularly valuable for those maintaining large balances which are subject to loss as a result of check fraud. The term loss is used because although the account owner may be able to prove the transaction occurred as a result of fraud and may be reimbursed, the financial institutions suffer a high economic impact as a result of the quantity of these fraudulent transactions. To simplify the discussion herein, the present system will be described primarily directed toward accounts associated with a credit card, or debit card, although it should be appreciated that any account from which transaction may be executed subject to a real or preset monetary limitation may be controlled using the present invention.

The present invention of providing account soft limits may be implemented in a number of alternative ways without departing from the claimed invention. It should be appreciated that any transaction processing element within the present transaction infrastructure which is configured for, or is capable of being configured to perform, checking of a user selected transaction limit prior to allowing a transaction to be executed is herein covered by one or more aspects of the present invention. By way of example and not of limitation, the inventive system and method may be practiced:

(1) Within the “transaction processing center” associated with the credit card, debit card, ACH based transaction, or other transaction network. The transaction processing center is more commonly referred to as a “card processing center” because the majority of transactions are currently associated with a card form of transaction token. The processing center may also be referred to as a “data center” as the associated account database (e.g. credit card account database, debit account database, and so forth) is generally located therein. A soft limit, or sub limit, is incorporated into the account database and the existing card verification or authorization process is augmented with a check on the soft limit or sub limit. It is contemplated that the soft limit feature will most often comprise a charge rate variable limit that has been adapted to allow for rapid substantially unilateral control as described within the teachings of the present invention. However, it will be appreciated that the soft limit may comprise per transaction limits, relative limits, rate limits, velocity limits, and any desired combinations thereof that are user controlled beneath the hard limits imposed by the issuer. Card processing centers of credit card companies, such as MasterCard®) for example have created a network of high level regional data centers associated with one or more forms of credit and debit card accounts. Integration within the databases at the regional data center level is preferable, in that inexpensive and ubiquitous deployment of the present system and method is more readily achieved.

(2) Within a separate system that is configured to process a transaction using information about the account as retrieved from a transaction processing center. In this case the database within the processing center maintains the soft limit within the database while the separate system does the actual processing for executing the verification/authorization process. For example, the issuing institution, or similar, may provide a customer interface, such as an 800 number, web site, or so forth, through which the account owner may make inquiries relating to their account. These system may communicate with accounting databases in the case of monetary accounts, or credit databases in the case of a credit account. Current features of these systems typically provide information on existing balance or credit limit, date of last payment, and so forth. It will be appreciated that the cardholder identity is already being verified within these systems to allow the cardholder to gain access to this information, wherein the additional programming required to provide basic soft transaction related interfacing features are easily incorporated without the necessity of creating programming for collecting an account number, primary identifier, secondary identifiers, and so forth.

This may also be implemented by other systems which perform conventional account related processing services. For instance, when a new credit card, or debit card, is received it must first be activated before use. This function may be performed by a third-party in communication with the computer associated with the account administrator, generally a credit card company.

(3) Within a separate system interfacing to a separate database. The soft limit is implemented external to the transaction processing center, and the soft limit information is contained within a positive file, a negative file, or other forms of account status databases that are accessed when verifying proposed transactions.

One of the ways this may be implemented is as an adjunct to the existing account (card) databases, such as so called positive and negative files, and other forms of databases utilized for verifying or validating accounts. The soft limit information may be implemented within the associated database, such as an additional one or more fields, that are checked by the programming within the card processing system which utilizes the soft limit information to check the transaction limits.

(4) Within a merchant-based system. The merchant may perform their own validation of a card wherein the prospective transaction is compared against the user selected soft transaction limits.

The above categories are generally applicable to processing for credit cards, debit cards, ATM cards, ACH based cards, and ACH based checks, and equivalent transaction account processing. The applicable system within the transaction infrastructure being associated with card organizations (e.g. MasterCard®, VISA®, etc.), card processing organizations, financial institutions, and organizations providing transaction services within the transaction infrastructure. It will be appreciated that the teaching of the present invention may be applied to these various entities and incorporated in various ways into equipment that operates within the transaction infrastructure.

The generation of overdraft or NSF type notices was previously mentioned, and it should be appreciated that conventional account owners often receive such a notice at least one week or more after a transaction is refused for NSF or the account has dipped into overdraft. This situation is very frustrating for account owners as by this time many more checks may have bounced. If the NSF occurred due to a fraudulent check being cashed, then the account owner may not be liable, but however will still be subjected to a grueling and humiliating experience. If the NSF occurred due to other reasons, the account owner will in addition have huge penalties to pay.

One simple aspect of the present invention includes altering conventional account processing procedures, such as for a checking account subject to check processing or the processing of any ACH based transaction (or similar off-line transaction mechanism), to generate an automated communication by email, FAX, IVR, and/or other means of communication to the account owner, or to their employer, family, relatives, (as indicated by the account owner) in response to overdraft conditions, such that they are immediately notified of a problem with potential NSF. The communication need not disclose the nature of the communication if security is an issue, and it need only urgently request that the account owner contact the financial institution, such as by phone, email, or web site. The communication may be automatically generated after the either the first or second settlement attempt.

An aspect of this invention is the communication of a preemptive warning prior to becoming overdrawn, such as when the associated balance dips below a user selected threshold, such as $100, $500, $1000, or any other desired direct settings or menu selected settings. In this way the user can be forewarned of a depleting account before becoming overdrawn.

The present system and method provides automated soft transaction limit control on the execution, and less preferably settlement, of transactions against a given account. The automated system may be implemented at any location in the transaction infrastructure through which a given transaction passes. At least a portion of the invention is preferably implemented within the regional data centers of credit card and debit card organizations, such as VISA®, MasterCard®, or similar card companies, wherein the soft limit value would be maintained and from which it would be retrieved in validating/authorizing a transaction prior to execution. The feature is herein referred to as providing soft transaction limits for controlling access to monetary accounts. The present invention, as described earlier may be implemented as a separate adjunct function for controlling an account, or provided as an additional service on existing systems which administer monetary transactions.

The present system and method may be implemented in a number of ways, a few of which have been briefly referred to, which were provided by way of example and not of limitation on the practice of the invention. The following describes preferred embodiments of the invention that may be readily practiced and easily understood. It should be appreciated that one of ordinary skill in art can modify the embodiments, especially in view of the teachings found herein, to implement a number of variations on the embodied invention without the need for creative effort and without departing from the teachings of the invention as claimed.

FIG. 1 illustrates a block diagram of a system 10 utilizing the soft transaction limits. An account owner, user 12 is represented with transaction infrastructure that allows the user to execute transactions with a series of merchants, represented herein as Merchants A 14, Merchants B 16, Merchants C 18, Merchants D 20. These transactions are controlled by user 12 by a set of transaction controls 22, which by way of example are represented by (A) a check 24 (or other forms of transaction tokens) can be sent, such by postal service 26, 28 to a merchant A 14 for executing a transaction although this is a far less preferred means of executing a transaction because delay times are uncertain in relation to the transaction being posted, also shown is the check being processed at the POS such as through a check reader wherein the checking account is generally verified (at least against a bad check database) and the check information immediately communicated; (B) a transaction token 30 shown as a magnetic stripe credit/debit/ATM card which is utilized at a point-of-sale system 32 of Merchant B 16 for executing a transaction; (C) a telephone 34, or equivalent, connected through the public switched telephone network (PSTN) 36, over which transaction token information is communicated to a telephone 38a, or a system 38b such as a server configured for processing telephone calls, which are connected to Merchant C 18; a cellular phone 40, PDA, or other wireless device configured for communicating over either the PSTN or equivalent cellular network is also shown for executing transactions with Merchant C; (D) a network enabled computer 42, or device incorporating a computer, for communicating transaction information including a transaction token, such as credit/debit card information, over Internet 44 with a server 46 associated with Merchant D 20.

It should be appreciated that each of these merchants 14, 16, 18, 20, upon receiving a transaction are configured for verifying/authorizing the transaction and for executing the transaction, which is represented by the small dotted line boxes near the output of each merchant block. The verification, authorization, and execution is typically performed by a card processing organizations, represented by card processor X 48, and Y 50. The link between the Merchants and the card processor, was at one time a dial-up connection, but these are being increasingly replaced with IP connections. The card processor process the merchant's electronic transactions and receive payments from the merchant for processing the electronic based transactions. The card processors 48, 50, connect to what is typically referred to as a regional data center 52 for a given form of transaction token. For example, on receiving a VISA® card to process, the card processor connects to the regional data center for VISA to get information necessary for verifying, authorizing, and executing. It will be appreciated that a number of card types are available, for example, VISA®, MasterCard®, Discover®, Novus®, and so forth. It will be appreciated that ACH based cards and electronic processed checks are handled within the ACH network, shown later.

The connection between the card processors 48, 50, and the regional data center 52 is shown as a hardlink, however it may be implemented by any convenient secure communication method. It will be appreciated that data in the regional data center is maintained by one or more computers 54 and a database 56 having records for each of the associated VISA accounts. It should further be appreciated that the computer and associated database may be implemented using any available methodology such as across a distributed data network.

Thus far, a simplified version of a generally conventional infrastructure has been shown for executing financial transactions using transactions tokens such as credit/debit cards, or the account information contained therein. As described previously, one of the significant drawbacks of the conventional transaction infrastructure is the susceptibility to fraud and the losses to merchants and credit card companies that extend into the billions of dollars annually.

The soft limit system and method described herein provides a mechanism for reducing these huge losses by substantially reducing the average available credit, or account balance, that is subject to the majority of transactions. The benefits are derived using the present system and method without preventing the account holder from executing very substantial transactions on up to the credit limit, to account limit. It is only necessary for the cardholder to bump their soft limit prior to executing a large transaction, which should occur infrequently in most cases, such as less than once a month. The user communicates an increased limit value referred to as a soft transaction limit value to cover the desired level of transactions. Of course this transaction limit must be within the available credit limit, or account balance, to which the account is subject. The account limits which can not be controlled unilaterally by the account owner are referred to as hard limits.

User 12 is provided with a set of soft limit controls 58 through which the account soft limit may be controlled within one or more data repositories that contain information utilized when verifying and/or authorizing transactions. An intermediary is shown providing a soft limit control interface 60, in this case adapted for receiving user soft limit control values in a number of different formats. The intermediary then communicates these to the regional data center 52, or other repository of information utilized for processing transactions. Although the intermediary may be hosted by any company, it is preferably hosted by card issuers, banks, or third party card service organizations, such as provide issuers with card activation services. It will be appreciated that the soft limit itself may comprise single transaction limits, rate limits such as daily transaction limits, relative limits, and so forth at the discretion of the issuing institution and optionally the account holder (cardholder). Control of the soft limits may be provided by any communication link that may be established between the account owner (cardholder) and a repository of account information utilized for verifying and authorizing transactions.

A number of the communication links which are contemplated to be the most popular are shown by way of example. A telephone 62, cell phone or similar personal communication device is shown connecting to the PSTN 64, or cellular network, to a server 66. Devices 68 which may connect through a PSTN, cellular, Internet, or other network are represented by a point-of-sale (POS) interface 70 and a PDA, or cellular phone configured for IP data communication. A computer 74, or similar network enabled device, is adapted for communicating through the Internet 44 with a server 76. An automated teller machine 78 may be programmed to perform the soft limit control, wherein it typically communicates data over one or more secure communication connections, herein referred to as an ATM network 80, with an associated server 82 providing the soft limit controls. It should be appreciated that the server functionality herein represented for soft limit control may be hosted within servers that are performing other functions within the transaction infrastructure. These servers are connected to regional data center 52 through an interface 84 and related software for implementing the soft limit functionality. The database of account information may require additional fields to properly control the soft limit functionality. A portion of a representative account record 86 are shown with conventional fields represented by an Account_Number field 88a, a conventional charge limit value Credit_Limit 88b. It will be appreciated that other hard limits may be alternatively utilized, such as account balance, as well as innumerable other fields not shown. A set of soft limit parameters are shown by way of example with a Soft_Limit_Flag 88c that determines if and how the soft limit is to be utilized. An identifier, or pointer to an identifier, is included against which account owner identification must be verified prior to allowing for a soft limit change is represented by the field Soft_Limit_ID 88d. It will be recognized that the identifier may comprise a new or an existing identifier, such as a PIN number, a portion of a social security number, a mother maiden name, a date of birth, a biometric identifier, and so forth. A default value for the soft limit is established as the “normal” setting of the soft limit as Soft_Limit_VDefault 88e. The current setting of the soft limit, including changes that have been recently made are represented as Soft_Limit_VCurrent 88f. Finally, a time value Soft_Limit_Time 88g determines the amount of time that the current soft limit should be active prior to reverting to the default value. The time value may represent the date and time at which the soft limit value should revert to the default based on predetermined soft limit times set for the account or user selection of the time for a soft limit change. Setting a soft limit to zero, or entering a special personal identifier associated with a “duress” condition or similar, should preferably cause the zero value to be maintained irrespective of a time limit, until such time as the account owner restores the desires setting. It should be readily appreciated that the soft limit fields and other control fields may be implemented within the software/database system in a number of alternative ways without departing from the teachings of the present invention.

It will be appreciated, that just as a number of mechanisms exist by which the soft transaction limit amount may be controlled, a number of mechanisms exist by which the default soft transaction limit may be initially set. It is contemplated that in many cases the issuing institution is expected to determine the set of constraints they want instituted on allowing users to alter the default soft transaction limit. Although at the discretion of the issuer the cardholder can be allowed to define a new “more appropriate” default value. In some cases it may be preferable to provide a fixed default soft transaction limit value that requires the cardholder to provide additional verification, or that is limited to being performed at the issuing bank or financial institution. One such case is when the use of the soft limit (sub credit limit) and a given default value by the cardholder is a condition of issuing/using the associated card; for instance the condition stipulated as a condition of obtaining the card, or tied to an incentive such as a bonus program wherein the account owner receives an incentive (i.e. year end percentage rebate, bonus, reduced account fees, or so forth) based on the use of a given default value.

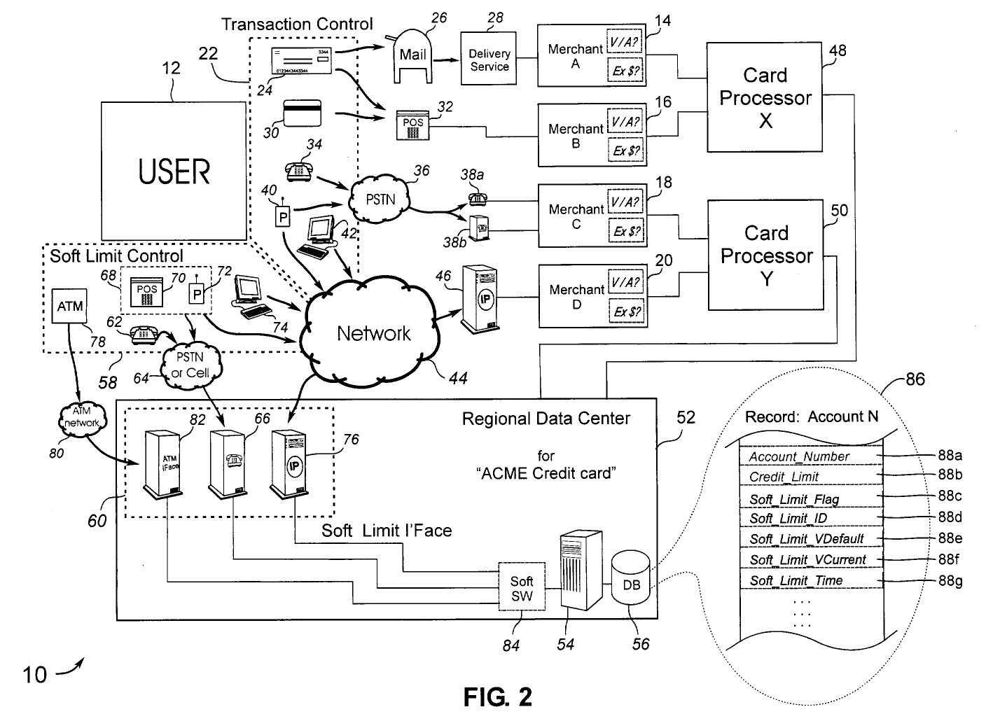

FIG. 2 illustrates a similar embodiment of FIG. 1, however, the equipment for providing the soft limit interface 60, depicted as servers 66, 76, 82, are shown integrated within the regional data center 52 and connecting up to software 84 associated with the data base server 54, or equivalent, computer. The soft limit interface 66 may be implemented using the same interface equipment as utilized for providing other forms of interfacing, such as existing communication interfaces to the card processors, banks and so forth.

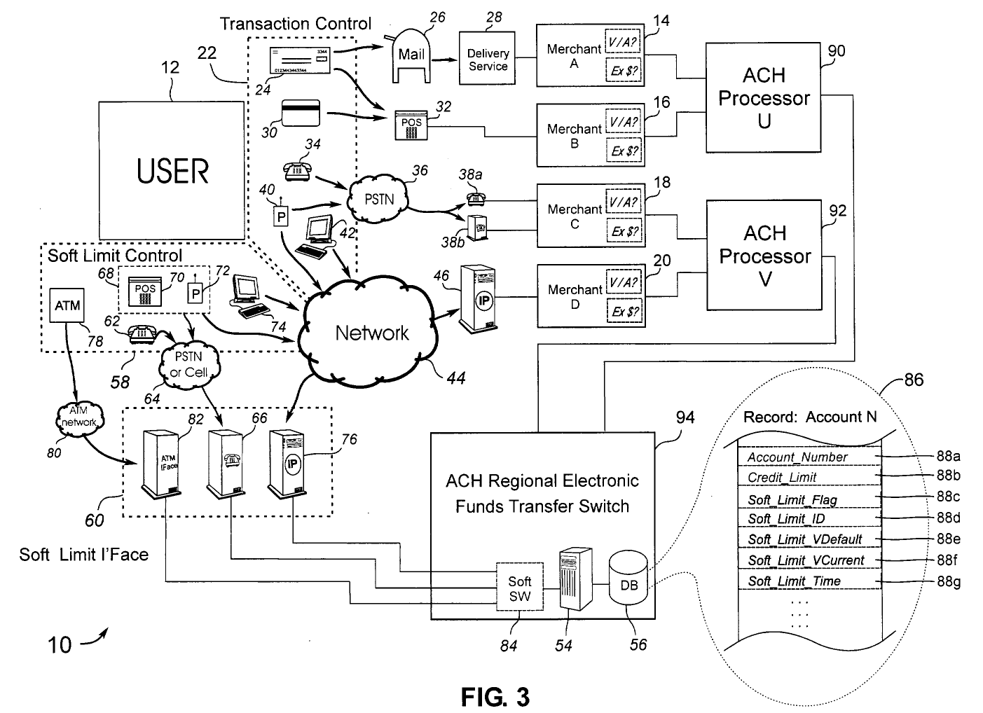

FIG. 3 depicts the use of the present invention for processing checks, and transaction tokens, such as debit cards, based on ACH (automated clearing house) transactions. It will be appreciated that the ACH system is a secure, private network that connects banks to one another by way of the Federal Reserve Board, or other ACH operators. Checks 24 being processed for executing a transaction are typically scanned, truncated, and converted to an ACH debit which is then transmitted through the ACH network and posted to the customer's account. A number of off-line debit card instruments are being issued based on ACH transactions, which have similar properties as a conventional credit card or on-line debit transaction, or ATM card. Processing of the ACH transaction is typically performed at what is often termed a regional electronic funds transfer network switch.

Checks 24 may be delivered such as by delivery services 26, 28, or more preferably scanned, communicated, and verified at the POS. It should be appreciated that although the ACH infrastructure may be represented in a number of ways and may utilize transaction verification data that is stored at different location within the infrastructure, the present invention provides for creating and maintaining a soft limit at or below the account hard limit that is utilized for limiting transactions, and may be implemented in these varied systems by one of ordinary skill in the art without inventive efforts, and without departing from the teachings of the present invention.

The ACH transactions are shown being processed at companies providing ACH processing services 90, 92, which connect to a larger regional ACH electronic funds transfer switch 94 that connects to banks (not shown) for settling transactions. It should be appreciated that any number or level of ACH processing entities may exist within the infrastructure without departing from the present invention. Similarly to previous examples the ACH regional efunds transfer switch includes computer resources 54 and an associated database 56 for retaining account information, including verifying accounts and limit information. The fields for controlling the soft transaction levels may be implemented as before, 88c through 88g, or may be configured in any desired structure without departing from the present invention.

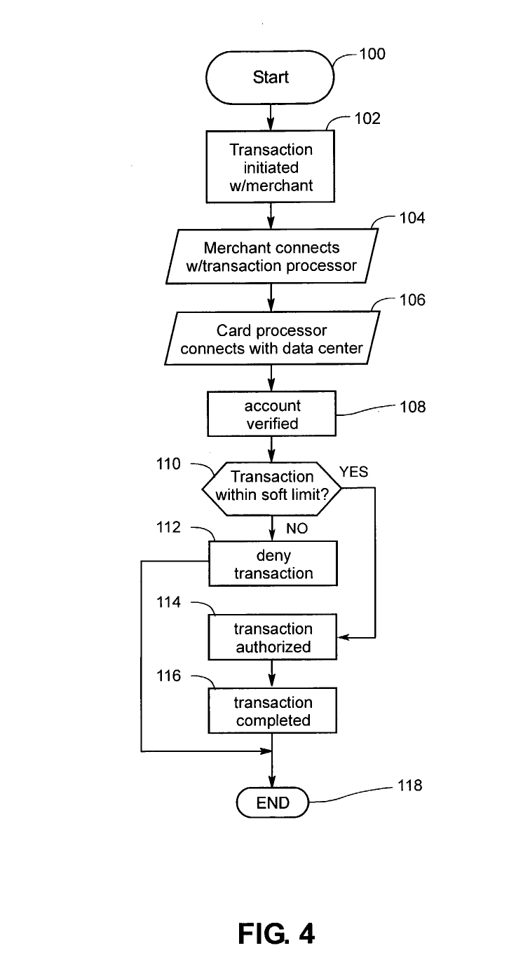

FIG. 4 illustrates a summary of transaction verification/authorization when using the soft limits for an account. It should be recognized that when a transaction is being verified/authorized, the soft limit may be retrieved from the account repository such at the regional data center, or other database from which data is retrieved for checking the transactions, and used in place of the conventional hard limits, or rate limits, as they are more constraining with regards to limiting a transaction. Alternatively, the information may be provided to augment the hard limit information already provided. One embodiment of a method for processing the soft limits for a credit transaction are shown in the figure for processing a credit card transaction. The account holder desires to execute a transaction with a merchant at block 100, and submits their transaction token to the merchant, such as swiping their credit card through a point of sale system with the intent of executing a transaction of a given value, which is represented by block 102. The merchant connects to a card processing facility, as per block 104, such as by dial-up, or a network connection such as an IP-based network. The card processing center in turn connects to one or more data repositories from which transaction verification/authorization data is retrieved. Block 106 represents this repository as a data center, such as the regional data center shown in FIG. 1. The account number for the given transaction token is verified at block 108, and optionally personal identifiers may be checked during verification. A check is then performed, as per block 110 to determine if the amount of the transaction exceeds the one or more soft limit. One preferred implementation of the soft limit utilizes a twenty-four hour day rate based limit, wherein during the check a comparison is made of the cumulative value of the proposed transaction and the transaction amounts which have been applied to the card within the given interval against the soft limit. This may be performed in a similar manner as a velocity limit, however, it is based on the soft limit value which is unilaterally, and readily settable by the account holder. It will be appreciated that this test may be performed at the data repository based on proposed transaction amount received from card processor, or alternately at a local processing facility based on information received from the data repository. If the transaction exceeds the soft limit, or the cumulative value, or other metric utilized, exceeds the soft limit, then the transaction is denied as represented by block 112 and the transaction terminated.

It will be appreciated that a special response may be generated that the denial is based on a soft limit value, wherein the account holder may then utilize one or more mechanisms for bumping up the soft limit. The transaction method may incorporate soft limit control settings in select circumstances, such as for generally secure POS transactions. It is contemplated that the account holder, such as at a POS, may enter an identifier such as a PIN and post a request to bump up their soft limit to complete the transaction. The identifier may be one that is traditionally associated with the account, or one that is utilized specifically for controlling the soft limit. It will be appreciated that the use of a biometric identifier at the POS would securely identify the party, wherein allowing them to alter soft limits does not generally pose an increased fiscal risk. If the transaction is within the soft limits then it is authorized as per block 114 and the transaction processing continues to conclusion at per block 116, which ends the transaction 118.

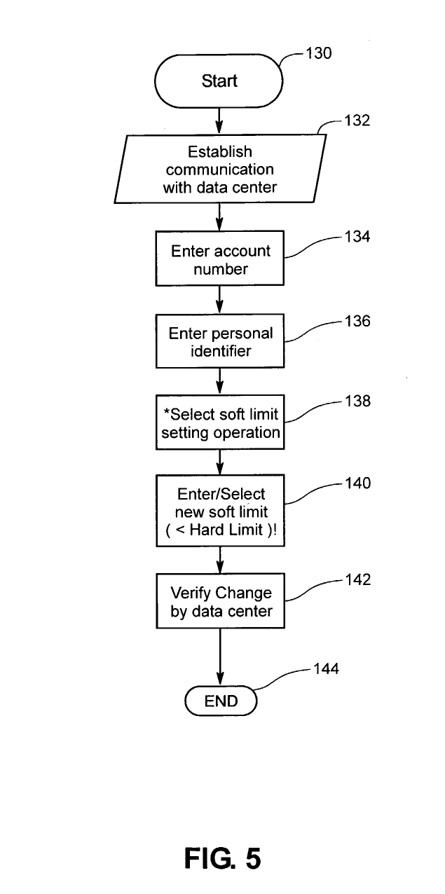

FIG. 5 represents a flowchart in which an account holder, separate from executing a transaction, alters their soft limit for a given account. The user starts the process 130, upon deciding they desire an increased limit. The account owner, also generally referred to as cardholder. The term “cardholder” is utilized herein as card are presently the typical form of transaction token although their predominance may be supplanted at some future time as other forms of transaction tokens such as smart cards, transaction enabled phones and PDAs, and so forth are employed with higher frequency. Communication is established, as represented in block 132, with a repository of transaction verification/authorization information, such as a regional data center, ACH processor, or a similar data base. The communication may be established via one or more other parties, such as card processing companies. The user enters an account number at block 134 and a personal identifier at block 136 to determine which account is being referenced and to establish that the user is authorized to make the change.

It should be readily recognized that in certain situations the account number and often the identification of the party has already been authorized (i.e. online banking, account information application, transaction device utilizing biometric or other identification), wherein steps 132, 134, and 136 may be skipped. An example of this is an ATM machine that requires card and PIN input prior to allowing any transactions to take place. It will be appreciated that the user may sign in with a reverse PIN, or other method of selecting a duress code. This duress code may also provide for preventing, or reducing the retrieval of cash from the ATM machine.

On a multipurpose interface, such as an ATM, the user then selects the soft limit control function as per block 138. It will be appreciated that in some contexts this may be inferred and is thereby optional. The account owner then enters a new soft limit value as represented in block 140 which is checked against the credit limits for the account, before being verified. In general the system will not enter a soft limit that exceeds the hard limits set for the account (system can be made to execute tightly controlled exceptions based on developed issuer cardholder programs). Additionally, another form of duress prevention may be employed by considering an attempt to set the soft limit above the account limit as a duress code, that would lock the soft limit at a zero value until the user made contact and established their identity and that they were not under duress, but made a mistake.

It will be appreciated that it would be rare for a party to establish such as high limit. Furthermore, a velocity feature may also be utilized as either a primary or secondary hard limit on the rate of transaction execution, wherein the soft limit must operate within the velocity feature. Upon entering the change, the system preferably responds to verify that the change has taken place, as per block 142, wherein the user knows that they may proceed with the planned escalated transaction level. The user may then end the session as block 144.

Another aspect of the invention was touched on above regarding the use of a “duress code” within ATM and similar cash advance machines. To prevent a criminal from forcing a person to withdraw significant funds from an ATM machine, or other “instant cash” form of machine, under duress. The account owner may in this case enter a reverse PIN number, or other code indicative of duress at an ATM to set their limit to zero, and which preferably causes the machine to act otherwise normally, except for generating a message that it is “out of money”, and that the transaction may be attempted later. The soft limit of the account would be nulled out to prevent the perpetrator from utilizing the card at other merchants establishments. No indication of the “duress” code having been entered should be visible. Alternatively, the machine may dole out a small value of cash, such as $20, with the indication that the account limit has been reached, wherein the perpetrator may be less suspicious and less likely to attempt using the card elsewhere. This provides a further aspect of the invention which may be readily implemented. It will be appreciated that the ATM software requires only simple programming changes that may be implemented by one of ordinary skill in the art.

Following is a list of steps that may be utilized in different portions of the present soft limit invention, such as in setting up the system and accounts thereof.

(Different Types of Transaction Processing may Require Slightly Different Setup)

Develop

Configure data center data records for soft T limits

Alter or create fields

Write new programming for handling variable soft T limit

Integrate existing routines

Sign Up Users

Establish Account or Retroactive With Soft T Limit Sign Up, or Agree to Program

*establish a default soft limit

data loaded to data center—

Utilize

Consumer proposes transaction with vendor

Transaction proposal from merchant rcvd by Card processor

Card processor connects with data center, or ACH node

Account verified

Transaction amount checked against soft limit value

Purchase validated/authorized

Transaction execution—info rcvd toward debit/settlement

Transaction completed

Transaction settled with banks

Alter Soft Limit

(Presumes Separate Facility Receives Soft Limit Setting)

at T=0

Establish communication with a soft limit control entity

Enter account number

Enter one or more identifiers

*Select soft T limit setting operation

*Communication established with regional data center

Enter new soft limit (preferably an over-ride to default value)−Enter/Select dollar value change (fixed bump(s), set value(s), i.e. press “5”−$500 etc.)

*Enter/select time span (fixed, select from list, set specific)

*Data transferred to data center

*Verify change request or completion

Exit—can use soft limits

at T=X (some later time, hours or days later)

*default soft limit reinstated (account protection increased)

(The communication and transfer with the data center may occur in non-real time if necessary. Preferably notice is given of this fact if it occurs.)

Personal electronic devices such as PDA, wireless telephones, smart cards and the like are becoming commonplace. Another aspect of the present invention makes use of this for simplifying user record keeping and transaction validation.

Short range wireless communication transmitter can be setup in merchant locations that broadcast information about the merchant, and with a multi-channel capability allow user to even enter queries perform interactively with a store information system. The repetitive broadcast would preferably contain store name, location, vendor ID, and preferably information about sales or other timely store information to aid the user.

Another aspect of in-store communication is to provide ports at the POS and drivers in the POS system for transmitting selected transaction information over the port to a personal electronic device, such as an organizer, PDA, wireless telephone, or other device capable of receiving and logging the information. The information provided preferably includes time and date, store information and department, along with descriptions of items purchased and cost. The port may comprise infra-red, wireless RF, inductive (i.e. like RFID), or a electrical connection such as USB or other standard. It will be appreciated that any common communication standard could be supported by the port. The software in the POS only need to be slightly modified for extracting the select fields from the available data and the data being registered from items being purchased such as scanned into the system, and outputting this data over the port. The POS system is configured for communicating any additional information (when available) about each items, such as return policy, manufacturers rebates or other policies, and the like.

The personal electronic device is configured with at least one application for registering the information from the POS (register). The information received by the personal electronic device can be entered within a transaction log and used for updating financial records. Furthermore, the personal electronic device can be configured to transmit the information or any portion of it to log the information remotely, or to validate the transaction indicating that the user is involved in the transaction.

Another aspect of this communication is supporting soft limits wherein if the soft limit threshold would be crossed the user, or more preferably the personal electronic device in an autonomous mode, can transmit new soft limit information either wirelessly, or provide identification information back through the port to the POS which in turn can validate extending the transaction past the soft limit of the account. The transaction infrastructure in this case being adapted as described earlier for requesting validation information to allow a transaction to cross the soft limit threshold. The information being returned from the personal electronic device may include a PIN type designator, biometric, or similar identifier that verifies identity.

It will be appreciated that the invention can be implemented in a variety of ways, and with various depths of features without departing from the teachings of the present invention. It should also be appreciated that even a simple implementation of soft limits can significantly reduce losses associated with fraud. The elements of the transaction infrastructure may be altered, the names of the structures for implementing soft limits may be changed, without departing from the teachings of the present invention, insofar as substantially equivalent functionality is rendered.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for controlling transaction authorization, comprising:
means for user control of a second transaction limit amount for an account of said user having a fixed first transaction limit amount;
means for submitting a transaction for execution wherein an amount and transaction token associated with said user account are submitted against which said transaction amount is to be posted; and
means for rejecting said transaction in response to information about prior transactions executed for said account if execution of said submitted transaction would result in exceeding the second transaction limit of said user account.

2. An apparatus as recited in claim 1, wherein said fixed first transaction limit comprises at least one limit to be imposed on transaction activity of said user account that may not be interactively set by said user.

3. An apparatus as recited in claim 2, wherein said fixed first transaction limit comprises either a credit limit, or a balance limit.

4. An apparatus as recited in claim 1, wherein said means for user control comprises:
a communication channel from said user to a networked computer database system upon which said second transaction limit is maintained; and
an interface configured for altering said second transaction limit amount in the electronic records of the user account in response to user input.

5. An apparatus as recited in claim 4, wherein said networked computer database system is additionally configured for maintaining additional account information.

6. An apparatus as recited in claim 4, wherein communication channel comprises signals passed over a wired or wireless telephone connection, an internet connection, or any electronic medium over which user input may be transmitted.

7. An apparatus as recited in claim 4:
wherein said communication channel is a telephone network;
wherein said interface is configured as an automated telephone application which generates voice prompts and registers user input as dual-tone multifrequency coded key inputs or voice responses.

8. An apparatus as recited in claim 1, wherein said means for submitting a transaction comprises a point of sale system which captures account information from said transaction token provided by said user and communicates this information to a database configured for registering charges against user accounts.

9. An apparatus as recited in claim 1, wherein said means for submitting a transaction comprises a communication link to a user account database system configured for authorizing or rejecting transactions for posting against the user account.

10. An apparatus as recited in claim 1, wherein said means for rejecting said transaction comprises a networked computer database system configured for rejecting a transaction if execution of said submitted transaction against the user account would cause said second transaction limit amount of said user account to be exceeded.

11. A system for controlling transaction authorization for user accounts, comprising:
at least one networked computer system capable of accessing account information for a plurality of users, said account information including fixed transaction limits not interactively selectable by said user, and soft transaction limits which may be selected by the user within the constraints of said fixed transaction limits;
programming on said at least one computer for,
updating said soft transaction limits in response to user input,
receiving information about prospective monetary transactions,
rejecting prospective monetary transactions whose execution would exceed said soft limit.

12. A system as recited in claim 11, wherein said programming on said networked computer system further comprises automatically resetting soft transactions limits to a default value after a predetermined time interval has elapsed since said soft transaction limit was set by the user to a value exceeding said default value.

13. A system as recited in claim 11, wherein said programming on said networked computer system further comprises automatically resetting soft transactions limits to a default value after a predetermined number of transactions have been executed since said soft transaction limit was set by the user to a value exceeding said default value.

14. A system as recited in claim 11, wherein updating of said soft transaction limits is performed on an automated interface configured to communicate with said networked computer system for selecting said soft transaction limits.

15. A method of controlling which transaction charges are to be accepted against a monetary account, under the control of the owner of said monetary account, comprising:
establishing a soft limit feature within the account database for administering monetary transactions with respect to said monetary account, by entering the following information into said database which is accessed for authorizing transaction charges associated with said monetary account by,
activating said soft limit feature within said monetary account of said owner, wherein the allowable range of said soft limit is constrained to be at or below the allowable credit limit, or credit balance, within said monetary account,
configuring a default soft limit value to which charge transactions executed against said account are to be limited, and above which said charge transactions are to be denied,
establishing at least one personal identifier for use by said owner of said monetary account, or parties authorized to use said monetary account by said owner, to be associated with the control of said soft limit feature for said monetary account;
modifying the value of said soft limit to alter the allowable extent to which charge transactions may be executed against said monetary account by,
establishing communication with an automated information system associated with said monetary account which is configured for authorizing transactions directed toward said monetary account based on database information retained in conjunction with said automated information system, communication being established by said owner, or a party authorized by said owner, for modifying portions of said database to which said authorization is responsive,
entering an account identifier for receipt by said automated information system for selecting which monetary account is being referenced by said owner or authorized party,
entering said at least one said personal identifier associated with said monetary account for receipt by said automated information system for validating the authority of said owner, or authorized party, to modify said soft limit values;
specifying a new soft limit value by said owner, or party authorized by said owner, to alter the monetary limit by which subsequent transactions are to be restrained;
wherein said soft limit alters the amount which may be charged to the associated account subject to the control of said account owner, or party authorized by said owner.

16. A method as recited in claim 15, wherein a credit card, debit card, or ATM card, is associated with said monetary account which is utilized for executing a monetary transaction.

17. A method as recited in claim 15, wherein said soft limit is expressed as a allowable transaction amount for a given period.

18. A method as recited in claim 17, wherein said period is a period expressed that may be expressed in hours or days.

19. A method as recited in claim 17, wherein said period is one day.

20. A method as recited in claim 15, wherein said default limit comprises a “normal” transaction limit typically substantially less than the credit limit, or credit balance associated with said monetary account.

21. A method as recited in claim 15, wherein said soft limit can be set to a value between zero monetary value on up through to a value equal to the credit limit, or credit balance.

22. A method as recited in claim 21, wherein said soft limit is subject to further restrictions below said credit limit, or credit balance, according to the limitations of use imposed for said monetary account.

23. A method as recited in claim 15, further comprising a time value to be associated with the change of said soft limit from said default value, whereupon after expiration of said time limit said soft limit being utilized within said automated information system returns to said default soft limit.

24. A method as recited in claim 23, wherein said time value comprises a period that may be represented as a number of hours, or days.

25. A method as recited in claim 24, wherein said time value comprises a period of 24 hours.

26. A method as recited in claim 15, further comprising establishing a duress code that may be entered in lieu of said personal identifier to minimize said soft limit or to otherwise prevent transactions from being executed against said monetary account.

27. A method as recited in claim 26, wherein said duress code comprises a modification of the personal identifier so that the owner, or party authorized by said owner, need not remember an additional identifier.

28. A method as recited in claim 15, wherein said communication is established with said automated information system over a telephone network, cellular network, or internet.
